(19) United States
(12) Patent Application Publication
(10) Pub. No.: US 2026/0192917 A1
(43) Pub. Date: Jul. 9, 2026

(54) SYSTEM AND METHOD FOR TIP-DRIVEN ROTORS AND WINGS WITH VERTICAL TAKE-OFF AND LANDING CAPABILITIES

(71) Applicant: Jobanpreet Singh NAGPAL, Chandigarh (IN)

(72) Inventor: Jobanpreet Singh NAGPAL, Chandigarh (IN)

(21) Appl. No.: 19/129,009

(22) PCT Filed: Nov. 9, 2023
(86) PCT No.: PCT/IB2023/061325

§ 371 Date: May 11, 2025

(30) Foreign Application Priority Data
Nov. 11, 2022 (IN) 202211064713

(51) Int. Cl. B64C 29/00; B64C 39/08

(52) U.S. Cl. CPC B64C 29/0033; B64C 39/08

(57) ABSTRACT

Disclosed is a tandem tip-driven rotor cum wing aircraft (100) having a vertical flight mode, and a horizontal flight mode. The tandem tip-driven rotor cum wing aircraft (100) includes an airframe (102), a fuselage (104), a first rotor-wing (106), a second rotor-wing (108), servo motors (112a, 112b, 112c, and 112d), thrusters (114a, 114b, 114c, and 114d), a first slip ring (116a), and a second slip ring (116b). The airframe (102) includes a forward end (118) and an aft end (120). The fuselage (104) is longitudinally extended between the forward end (118) and the aft end (120) of the airframe (102). The first rotor-wing (106) includes a first rotatable portion and a second rotatable portion. The second rotor-wing (108) includes a third rotatable portion, and a fourth rotatable portion. The first rotor-wing (106) and the second rotor-wing (108) are arranged in a tandem sequence and rotatably mounted on the fuselage (104).

### FIELD OF INVENTION

The present invention is generally related to avionics, and more particularly to a tandem tip-driven rotor cum wing with 180-degree pitch variance aircraft having a vertical flight mode and a horizontal flight mode.

### BACKGROUND OF INVENTION

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Aircraft have served diverse purposes such as transportation, reconnaissance, and military applications for several decades. Throughout history, various types of aircraft have been designed to cater to specific needs. Conventional airplanes rely on wings to generate aerodynamic lift, enabling efficient and rapid horizontal flight.

Currently, several techniques are available for transitioning between vertical and horizontal flight modes. These methods typically involve tilting rotors, simultaneously tilting both wings and rotors or integrating rotor and wing propulsion systems. However, these existing approaches often fall short when it comes to implementing a hybrid model that can seamlessly switch between vertical and horizontal flight, optimizing forward flight capabilities, endurance, and overall performance.

In particular, helicopters are known for their vertical take-off and landing (VTOL) capabilities, making them a preferred choice in certain scenarios. However, helicopters are notorious for their high fuel consumption or battery usage, which can be a significant drawback.

Therefore, a pressing need arises for a system and method that combines tip-driven rotors and wings, granting an aircraft vertical take-off and landing (VTOL) capabilities while effectively addressing the challenges and limitations mentioned above. This new system aims to revolutionize the aviation industry by delivering a unique solution to these issues and provides a tandem tip-driven rotor cum wing aircraft having a vertical flight mode, and a horizontal flight mode.

Thus, in view of the above, there is a long-felt need in the aviation industry to address the aforementioned deficiencies and inadequacies.

Further limitations and disadvantages of conventional approaches will become apparent to one of skill in the art through the comparison of described systems with some aspects of the present disclosure, as outlined in the remainder of the present application and regarding the drawings. In some embodiment, the numbers expressing quantities or dimensions of items, and so forth, used to describe and claim certain embodiment of the invention are to be understood as being modified in some instances by the term “about.”

### SUMMARY OF THE INVENTION

A system and method for tip-driven rotors and wings with vertical take-off and landing capabilities are provided substantially, as shown in and/or described in connection with at least one of the figures.

An aspect of the present disclosure relates to a tandem tip-driven rotor cum wing aircraft having a vertical flight mode, and a horizontal flight mode. The tandem tip-driven rotor cum wing aircraft includes an airframe, a fuselage, a first rotor-wing, a second rotor-wing, a plurality of servo motors or actuators, a plurality of thrusters or engines, a first slip ring, and a second slip ring. The airframe includes a forward end and an aft end. The fuselage is longitudinally extended between the forward end and the aft end of the airframe. The first rotor-wing includes a first rotatable portion and a second rotatable portion. The second rotor-wing includes a third rotatable portion, and a fourth rotatable portion. The first rotor-wing and the second rotor-wing are arranged in a tandem sequence and rotatably mounted on the fuselage. Each of the first rotor-wing and the second rotor-wing include a plurality of leading edges. Each of the first rotatable portion, the second rotatable portion, the third rotatable portion, and the fourth rotatable portion are connected to their respective servo motors which actuate the rotation motion of each rotatable portion individually on signals from a proportional-integral-derivative (PID) controller. The PID controller controls each of the servo motors of the first rotatable portion, the second rotatable portion, the third rotatable portion, and the fourth rotatable portion. The thrusters are connected to each of the leading edges of the first rotor-wing and the second rotor-wing to provide a plurality of thrust directions. The PID controller utilizes at least eight channels to control the servo motors and the thrusters. The first slip ring connects the first rotor-wing with the fuselage through a shaft. The second slip ring connects the second rotor wing with the fuselage. The first slip ring and the second slip ring include a plurality of brakes to lock the first rotor-wing and the second rotor-wing perpendicular to the fuselage in a transition from the vertical flight mode to the horizontal flight mode.

In an aspect, the airframe includes a flight controller to manage and control various flight operations to ensure stable, safe, and autonomous flight.

In an aspect, during vertical flight mode, the leading edges and the thrust directions of both halves of each of the first rotor-wing and the second rotor-wing are oriented in different directions to enable the first rotor-wing and the second rotor-wing to spin and generate lift, thereby functioning as a tip-driven rotor aircraft.

In an aspect, each of the first rotor-wing and the second rotor-wing has a pitch of both halves of each of the first rotor-wing, and the second rotor-wing has a 180° range of motion to enhance stability and maneuverability during the vertical flight mode. In an aspect, the first rotor-wing is a front rotor-wing and the second rotor-wing is a rear rotor-wing. the pitch or the varying pitch of both the front rotor-wing and the rear rotor-wing, when actuated in tandem, may also add a yaw authority in the vertical flight mode as well unlike in traditional tip-driven rotorcrafts yaw authority cannot be achieved by varying the revolutional speed of the rotor.

In an aspect, the fuselage is elevated from the forward end to avoid the intervention of the first rotor-wing, and the second rotor-wing.

In an aspect, the first rotor-wing, and the second rotor-wing, during the vertical flight mode, rotate in counter-rotation to produce a vertical lift.

In an aspect, the first rotor-wing, and the second rotor-wing, during the horizontal mode, are not rotating, and are positioned to produce forward movement as fixed wings.

In an aspect, the first rotor-wing and the second rotor-wing are connected to the fuselage through the first slip ring and the second slip ring respectively for power and data-signal transmission to the servo motors and a plurality of avionics of the first rotor-wing, and the second rotor-wing to ensure free rotation.

In an aspect, the first rotor-wing and the second rotor-wing comprise a plurality of pivot portions with the servo motors to actuate a varying pitch rotation electronically to provide a stable transition from the vertical flight mode to the horizontal flight mode.

In an aspect, the thrusters move along with the varying pitch to create a thrust vectoring to provide efficient braking of the first rotor-wing, and the second rotor-wing.

Accordingly, one advantage of the present invention is that the tip-driven rotor transits into fixed wings for the transition from vertical flight to horizontal (forward) flight.

Accordingly, one advantage of the present invention is its enhanced efficiency compared to traditional quad planes and single-rotor with wing aircraft. Additionally, it provides yaw control during the vertical flight due to its tandem configuration as explained above.

In an exemplary aspect, the present tandem tip-driven rotor cum wing aircraft transits into a tandem wing aircraft from a tandem helicopter. The tip-driven rotors provide the VTOL capabilities of a helicopter and when the rotors transit into wings mid-air they get the long endurance, long-range flight capabilities of a fixed-wing aircraft.

These features and advantages of the present disclosure may be appreciated by reviewing the following description of the present disclosure, along with the accompanying figures wherein reference numerals refer to like parts.

### BRIEF DESCRIPTION OF THE DRAWINGS

The accompanying drawings illustrate the embodiment of apparatuses, devices, systems, methods, and other aspects of the disclosure. Any person with ordinary skills in the art will appreciate that the illustrated element boundaries (e.g., boxes, groups of boxes, or other shapes) in the figures represent an example of the boundaries. In some examples, one element may be designed as multiple elements, or multiple elements may be designed as one element. In some examples, an element shown as an internal component of one element may be implemented as an external component in another and vice versa. Furthermore, the elements may not be drawn to scale.

Various embodiments will hereinafter be described in accordance with the appended drawings, which are provided to illustrate, not limit, the scope, wherein similar designations denote similar elements, and in which:

FIG. 1 illustrates a top view of a tandem tip-driven rotor cum wing aircraft in a vertical flight mode, in accordance with at least one embodiment.

FIG. 2 illustrates a side view of the tandem tip-driven rotor cum wing aircraft in the vertical flight mode, in accordance with at least one embodiment.

FIG. 3 illustrates a top view of the tandem tip-driven rotor cum wing aircraft in a horizontal flight mode, in accordance with at least one embodiment.

FIG. 4 illustrates a side view of the tandem tip-driven rotor cum wing aircraft in the horizontal flight mode, in accordance with at least one embodiment.

FIG. 5 illustrates a forward view of the tandem tip-driven rotor cum wing aircraft in the horizontal flight mode, in accordance with at least one embodiment.

FIG. 6 illustrates a first closer-side view of the rotor-wing, in accordance with at least one embodiment.

FIG. 7 illustrates a second closer-side view of the rotor-wing, in accordance with at least one embodiment.

FIG. 8 illustrates a block diagram of the various components of the tandem tip-driven rotor cum wing aircraft, in accordance with at least one embodiment.

### DETAILED DESCRIPTION OF THE EMBODIMENTS HEREIN

The present disclosure is best understood with reference to the detailed figures and description set forth herein. Various embodiments have been discussed with reference to the figures. However, those skilled in the art will readily appreciate that the detailed descriptions provided herein with respect to the figures are merely for explanatory purposes, as the methods and systems may extend beyond the described embodiments. For instance, the teachings presented and the needs of a particular application may yield multiple alternative and suitable approaches to implement the functionality of any detail described herein. Therefore, any approach may extend beyond certain implementation choices in the following embodiments.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Methods of the present invention may be implemented by performing or completing manually, automatically, or a combination thereof, selected steps or tasks. The term “method” refers to manners, means, techniques, and procedures for accomplishing a given task including, but not limited to, those manners, means, techniques, and procedures either known to or readily developed from known manners, means, techniques, and procedures by practitioners of the art to which the invention belongs. The descriptions, examples, methods, and materials presented in the claims and the specification are not to be construed as limiting but rather as illustrative only. Those skilled in the art will envision many other possible variations within the scope of the technology described herein.

Additionally, as used herein, the term ‘circuit’ or ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer-readable memories that work together to cause an apparatus to perform one or more functions described herein; and (c) circuits, such as, for example, a microprocessor(s) or a portion of a microprocessor(s) or microcontroller(s), that require software or firmware for operation even if the software or firmware is not physically present.

The present disclosure provides a tandem tip-driven rotor cum wing aircraft having a vertical flight mode, and a horizontal flight mode. In response to specific requirements, the tip-driven rotor-wings of the tandem tip-driven rotor cum wing aircraft seamlessly transition into fixed wings, enabling the shift from vertical flight to horizontal, or forward flight. This tandem tip-driven rotor cum wing aircraft metamorphoses from a tandem helicopter into a tandem wing aircraft during this transition. The tip-driven rotors provide the vertical take-off and landing (VTOL) capabilities characteristic of helicopters. However, when these rotors transition into wings mid-air, the aircraft gains the advantages of extended endurance and long-range flight typical of fixed-wing aircraft. The design of these tip-driven rotors, which double as wings, is quite ingenious. In vertical flight mode, the leading edge and propulsion (thrust direction) of both halves of the first rotor-wing, and the second rotor-wing operate in different directions, allowing the wing to spin and generate lift, akin to a helicopter's rotor. This unique configuration classifies it as a tip-driven rotor aircraft. The pitch of both halves of the rotor boasts a 180° or 360° range of motion, enhancing maneuverability and, more importantly, facilitating the transition from tip-driven rotor to wing, enabling a seamless switch from vertical to forward flight. The thrusters or propulsion systems are located close to the leading edges, or even directly on the leading edges, spin the rotor, distinguishing it from a traditional helicopter with a center engine-driven rotor. When the leading edges and propulsion system of both halves align in the same direction, the aircraft functions as a fixed-wing aircraft. In rotor mode, during vertical flight mode, pitch variations assist in changing altitude and the aircraft's direction. In wing mode, during forward flight or horizontal flight mode, varying the pitch of the wings serves as control surfaces, offering the aircraft the 3-axis control typical of traditional fixed-wing aircraft. The rotor-wing assembly is connected to the fuselage through a slip ring, which facilitates power and data-signal transfer to the propulsion system and avionics of the rotor-wing while allowing free rotation. The slip rings come equipped with brakes to secure the wing perpendicular to the fuselage during the transition from rotor to wing. The dynamic interplay of pitch and propulsion combinations ensures a smooth transition from vertical flight to forward flight.

As used herein, and unless the context dictates otherwise, the term “configured to” or “coupled to” is intended to include both direct coupling (in which two elements that are coupled to each other contact each other) and indirect coupling (in which at least one additional element is located between the two elements). Therefore, the terms “configured to”, “configured with”, “coupled to” and “coupled with” are used synonymously. Within the context of this document terms “configured to”, “coupled to” and “coupled with” are also used euphemistically to mean “communicatively coupled with” over a network, where two or more devices can exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, utilized, or combined with other elements, components, or steps that are not expressly referenced.

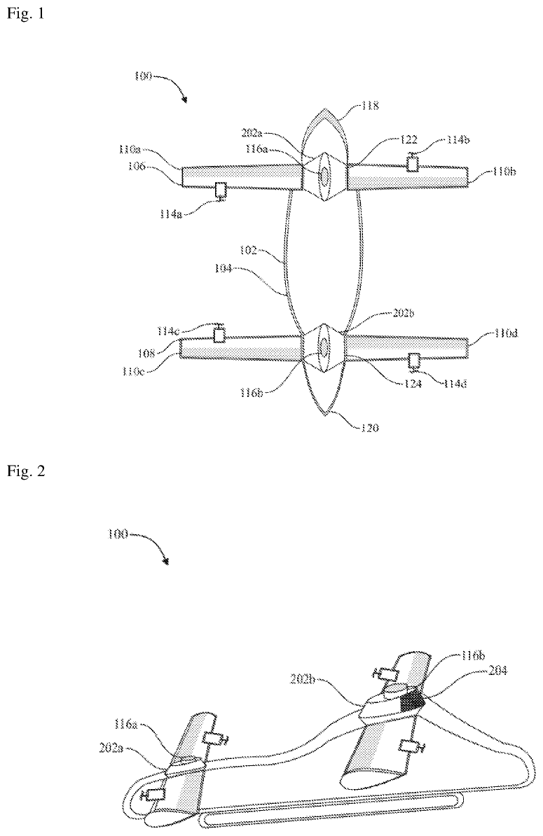

FIG. 1 illustrates a top view of a tandem tip-driven rotor cum wing aircraft (100) in a vertical flight mode, in accordance with at least one embodiment. FIG. 1 is explained in conjunction with FIG. 2-F IG. 8. The tandem tip-driven rotor cum wing aircraft (100) includes an airframe (102), a fuselage (104), a first rotor-wing (106), a second rotor-wing (108), a plurality of servo motors (112a, 112b, 112c, and 112d), a plurality of thrusters (114a, 114b, 114c, and 114d), a first slip ring (116a), and a second slip ring (116b). The airframe (102) includes a forward end (118) and an aft end (120). The fuselage (104) is longitudinally extended between the forward end (118) and the aft end (120) of the airframe (102). The first rotor-wing (106) includes a first rotatable portion and a second rotatable portion. The second rotor-wing (108) includes a third rotatable portion and a fourth rotatable portion which is also known as a varying pitch (similar to the varying pitch propeller in a helicopter but with a higher range of motion and without the linkage and without the complex mechanism of a helicopter varying pitch rotor). The first rotor-wing (106) and the second rotor-wing (108) are arranged in a tandem sequence and rotatably mounted on the fuselage (104). Each of the first rotor-wing (106) and the second rotor-wing (108) include a plurality of leading edges (110a, 110b, 110c, and 110d). Each of the first rotatable portion, the second rotatable portion, the third rotatable portion, and the fourth rotatable portion are connected to their respective servo motors (112a, 112b, 112c, and 112d) which actuate the rotation motion of each rotatable portion individually on signals from a proportional-integral-derivative (PID) controller (802). In an embodiment, the servo motors (112a, 112b, 112c, and 112d) are electric geared devices that actuate the rotation. In an embodiment, the varying pitch is the rotatable motion of the wing.

The PID controller (802) controls each of the servo motors (112a, 112b, 112c, and 112d) of the first rotatable portion, the second rotatable portion, the third rotatable portion, and the fourth rotatable portion. The thrusters (114a, 114b, 114c, and 114d) are connected to each of the leading edges (110a, 110b, 110c, and 110d) of the first rotor-wing (106) and the second rotor-wing (108) to provide a plurality of thrust directions. The PID controller (802) utilizes at least eight channels to control the servo motors (112a, 112b, 112c, and 112d), and the thrusters (114a, 114b, 114c, and 114d). Out of the eight channels, four channels are used to control the four servo motors (112a, 112b, 112c, and 112d), and four channels are used to control the four thrusters (114a, 114b, 114c, and 114d). In an embodiment, the PID controller (802) is a common control loop feedback mechanism used to control various processes and systems of the tandem tip-driven rotor cum wing aircraft (100). Examples of these processes and systems include but are not limited to motion control, pressure control, temperature control, and flight control. According to an embodiment herein, the PID controller (802) is used to adjust the control surfaces to maintain the desired aircraft attitude and heading. In an embodiment, the PID controller (802) is a part of the flight controller (902), and the PID controller (802) in the present disclosure controls the thrust of each of the four thrusters or propeller-motor or propeller-engine combinations along with each of the four servo motors actuating the pitch of each of the four rotating parts of the rotor cum wings. The changeable pitch eliminates the need for ailerons and elevators, an additional rudder would only be required in the horizontal flight mode which is usually placed on the vertical stabilizer.

The first slip ring (116a) connects the first rotor-wing (106) with the fuselage (104) through a shaft. The second slip ring (116b) connects the second rotor-wing (108) with the fuselage (104). The first slip ring (116a) and the second slip ring (116b) include a plurality of brakes to lock the first rotor-wing (106), and the second rotor-wing (108) perpendicular to the fuselage (104) in a transition from the vertical flight mode to the horizontal flight mode.

In an embodiment, the airframe (102) further includes a flight controller (902) to manage and control a plurality of flight operations to ensure stable, safe, and autonomous flight. According to an embodiment herein, the flight controller (902) includes various sensors such as an accelerometer, a gyroscope, a barometer, a magnetometer, a GPS, and an airspeed sensor. In another embodiment, the flight controller (902) is programmable to adapt to various aircraft designs.

In an embodiment, the flight controller (902) is configured to help stabilize, navigate, and control the tandem tip-driven rotor cum wing aircraft (100). Further, the flight controller (902) is employed to maintain stability and enable GPS-assisted features. Additionally, the flight controller (902) manages the transition between vertical and horizontal flight modes and adjusts the orientation of rotors for various flight modes.

In another embodiment, the first rotor-wing (106) and the second rotor-wing (106) may utilize one or more hall sensors that are connected with the first slip ring (116a) and the second slip ring (116b) to identify and align the positioning of the first rotor-wing (106), and the second rotor-wing (108). In an embodiment, during vertical flight mode, the leading edges (110a, 110b, 110c, and 110d) and the thrust directions of both halves of each of the first rotor-wing (106) and the second rotor-wing (106) are oriented in different directions to enable the first rotor-wing (106) and the second rotor-wing (106) to spin and generate lift, thereby functioning as a tip-driven rotor aircraft. In another embodiment, the hall sensors are connected to the flight controller (902) for feedback on the position of the first rotor-wing (106) and the second rotor-wing (106).

In an embodiment, the tandem tip-driven rotor cum wing aircraft (100) is not restricted to but primarily designed for use in unmanned aerial vehicles (UAVs) or autonomous aircraft. In an embodiment, the first rotor-wing (106), and the second rotor-wing (108), during the vertical flight mode, rotate in counter-rotation to produce a vertical lift. In an embodiment, the first rotor-wing (106), and the second rotor-wing (108), during the horizontal mode, are not rotating, and are positioned to produce forward movement as fixed wings.

FIG. 2 illustrates a side view of the tandem tip-driven rotor cum wing aircraft (100) in the vertical flight mode, in accordance with at least one embodiment. In an embodiment, the first rotor-wing (106) and the second rotor-wing (108) are connected to the fuselage (104) through the first slip ring (116a) and the second slip ring (116b) respectively for power and data-signal transmission to the servo motors (112a, 112b, 112c, and 112d) or propulsion systems and a plurality of avionics (904) of the first rotor-wing (106), and the second rotor-wing (108) to ensure free rotation. In an embodiment, the avionics (904) include various electronic systems for communication, navigation, surveillance, and various other functions. FIG. 2 also depicts non-pitching portions of the first rotor-wing (106) and the second rotor-wing (108). In an embodiment, each of the first slip ring (116a) and the second slip ring (116b) are connective to their vertical stabilizers (202a, and 202b). The vertical stabilizers (202a, and 202b) are fixed-wing sections to provide stability for the tandem tip-driven rotor cum wing aircraft (106), to keep it flying straight. Further, the vertical stabilizers (202a, and 202b) are configured to prevent side-to-side, or yawing (a rudder 204 is incorporated on the rear vertical stabilizer 202b which is considerably taller than the front vertical stabilizer 202a), motion of the aircraft nose. In an embodiment, each of the first slip ring (116a) and the second slip ring (116b) are configured to transmit Pulse-width Modulation (PWM) signal, flight control signal, and blade position data between the avionics on the wing and the flight controller (902) or the PID controller (802). According to an embodiment herein, the first slip ring (116a) and the second slip ring (116b) enable a continuous rotation to the first rotor-wing (106) and the second rotor-wing (108). The first slip ring (116a) and the second slip ring (116b) allow the transmission of electrical signals and power to the first rotor-wing (106) and the second rotor-wing (108), which is needed for the servo motors (112a, 112b, 112c, and 112d) and thrusters (114a, 114b, 114c, and 114d) to work effectively. Further, the first slip ring (116a) and the second slip ring (116b) transmit the data and signals without twisting the electrical wires.

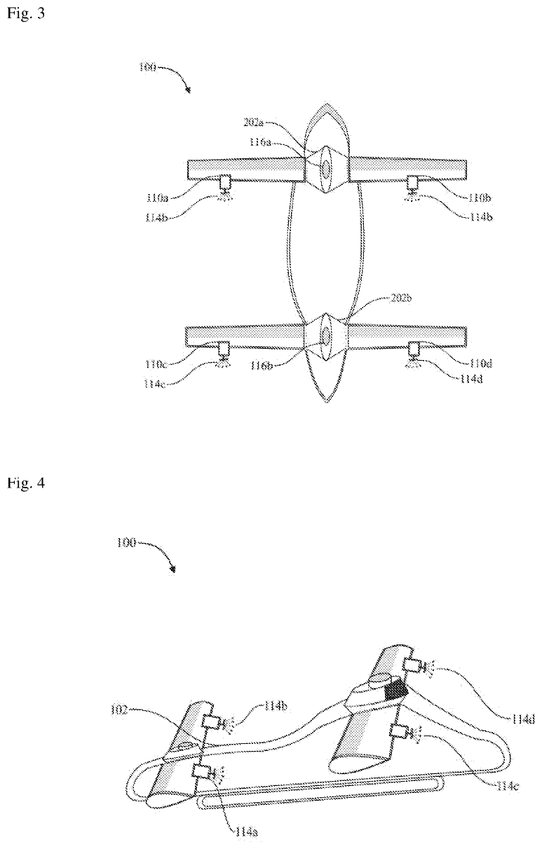

FIG. 3 illustrates a top view of the tandem tip-driven rotor cum wing aircraft (100) in a horizontal flight mode, in accordance with at least one embodiment. FIG. 3 is explained in conjunction with FIG. 1. The first rotor-wing (106) and the second rotor-wing (108) include at least four pivot portions (FIG. 1 depicts two pivot portions 122, and 124, the remaining two pivot portions are not shown) with the servo motors (112a, 112b, 112c, and 112d) to actuate a varying pitch rotation electronically to provide a stable transition from the vertical flight mode to the horizontal flight mode. In an embodiment, the thrusters (114a, 114b, 114c, and 114d) move along with the varying pitch to create thrust vectoring to provide efficient braking of the first rotor-wing (106), and the second rotor-wing (108). In another embodiment, the thrusters (114a, 114b, 114c, and 114d) will gradually point downwards before transitioning to maintain altitude and then gradually point backward to initiate horizontal forward flight. In an embodiment, the pitch and thruster combo will gradually move to it is the complete transition to provide a lift component before adequate forward speed is achieved. In an embodiment, the varying pitch of the first rotor-wing, and the second rotor-wing act as a plurality of control surfaces to provide a 3-axis control in the wing mode. In an embodiment, the airframe (102) includes a yaw authority in the vertical flight mode with tandem configuration.

FIG. 4 illustrates a side view of the tandem tip-driven rotor cum wing aircraft (100) in the horizontal flight mode, in accordance with at least one embodiment. FIG. 4 is explained in conjunction with FIG. 1. The fuselage (104) is elevated from the forward end (118) to avoid the intervention of the first rotor-wing (106), and the second rotor-wing (108).

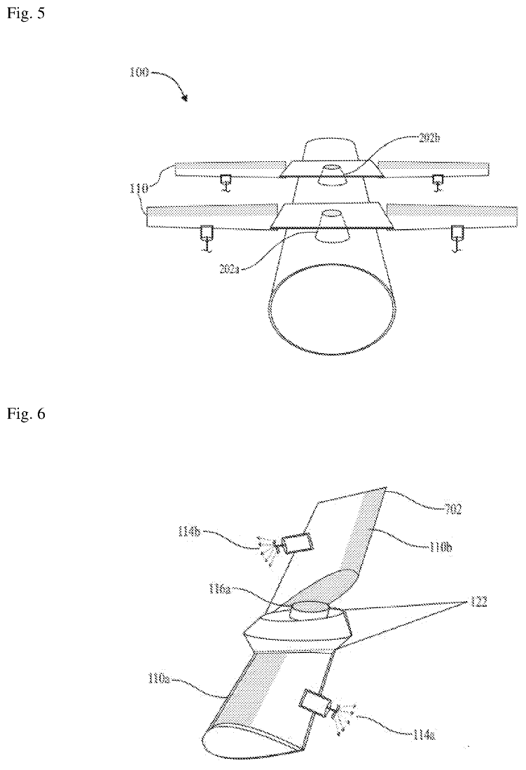

FIG. 5 illustrates a forward view of the tandem tip-driven rotor cum wing aircraft in the horizontal flight mode or a forward flight mode, in accordance with at least one embodiment. In an embodiment, all the thrusters (114a, 114b, 114c, and 114d) point down before transitioning to the forward/horizontal flight mode. Further, the thrusters (114a, 114b, 114c, and 114d) increase thrust even further for the first rotor-wing (106), and the second rotor-wing to compensate for the halting rotor and provide adequate lift for maintaining the altitude during the transition (108) and the pitch of the rotor/wing in this position provides maximum drag to the rotor/wing helping it along the brakes to stop completely. The position of the first rotor-wing (106), and the second rotor-wing (108) shown in FIG. 4 help in braking and a mechanical lock would lock the first rotor-wing (106), and the second rotor-wing (108) for the forward flight mode. In an embodiment, all the leading edges (110a, 110b, 110c, and 110d) are positioned upward in the forward flight mode. In operation, thrust reduces for transition to the forward flight mode, as to wing start to pitch forward, lift from the wing increases as airflow increase. Further, all the thrusters (114a, 114b, 114c, and 114d) point backward for the forward flight mode.

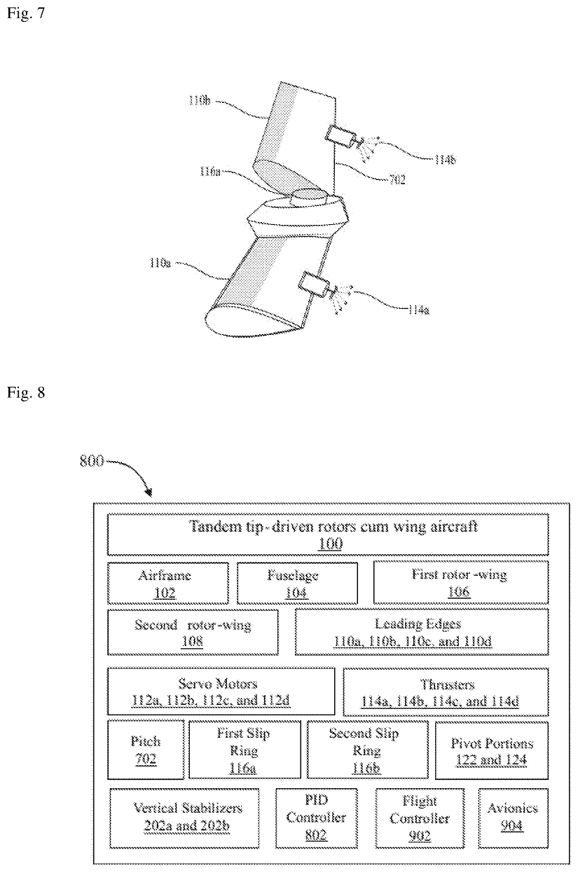

In an embodiment, each of the first rotor-wing (106) and the second rotor-wing (108) having a pitch (702) of both halves of each of the first rotor-wing (106) and the second rotor-wing (106) have a 180° or 360° range of motion to enhance stability and maneuverability during the vertical flight mode. FIG. 6 illustrates a first closer-side view of the rotor-wing, in accordance with at least one embodiment. FIG. 6 depicts that the pitch (702) rotates 180 or 360 degrees for transition to the forward flight mode. FIG. 7 illustrates a second closer-side view of the rotor-wing, in accordance with at least one embodiment. FIG. 7 depicts that the pitch (702) acts as a control surface in the forward flight mode.

FIG. 8 illustrates a block diagram (800) of the various components of the tandem tip-driven rotors cum wings aircraft (800), in accordance with at least one embodiment. During the vertical flight mode, both halves of the first rotor-wing (106) and second first rotor-wing (108) feature the leading edges (110a, 110b, 110c, and 110d) and propulsion (thrust direction) that point in different directions. This configuration allows the wing to spin, akin to a helicopter's rotor, creating lift-a defining characteristic of a tip-driven rotor aircraft. Each half of the first rotor-wing (106) and the second rotor-wing (108) possesses a full 360° range of motion, enhancing maneuverability and, critically, enabling a seamless transition from the tip-driven rotor to the wing for the switch from the vertical flight mode to the forward flight mode.

The propulsion, located near the wingtips (110a, 110b, 110c, and 110d), imparts spin to the rotor, designating it as a tip-driven rotor rather than a central engine-shaft-driven rotor as seen in traditional helicopters. When the leading edges (110a, 110b, 110c, and 110d) and propulsion of both halves align in different directions, the assembly functions as a rotor. However, when the leading edges (110a, 110b, 110c, and 110d) and propulsion align in the same direction, it operates as a fixed wing, harnessing the benefits of both configurations. In vertical flight mode or rotor mode, which corresponds to vertical flight, pitch variations play a pivotal role in altering the aircraft's altitude and direction. In horizontal flight mode or wing mode, corresponding to forward flight, the dynamic pitch adjustments of the wings serve as control surfaces, affording the aircraft 3-axis control with the help of a rudder, akin to that of a traditional fixed-wing aircraft.

The rotor/wing is seamlessly integrated with the fuselage through a slip ring mechanism, facilitating power and data-signal transfer to the propulsion system and avionics of the rotor/wing while ensuring unrestricted rotation. These slip rings are equipped with brakes, allowing the wing to be securely locked perpendicular to the fuselage during the transition from rotor to wing mode. The hall sensors aid in identifying and aligning the position of the wing, adding to the precision of this pivotal maneuver. The combination of variable pitch and propulsion adjustments ensures a smooth transition from vertical flight to forward flight.

No language in the specification should be construed as indicating any non-claimed element as essential to the practice of the invention.

It will be apparent to those skilled in the art that various modifications and variations can be made to the present invention without departing from the scope of the invention. There is no intention to limit the invention to the specific form or forms enclosed. On the contrary, the intention is to cover all modifications, alternative constructions, and equivalents falling within the scope of the invention, as defined in the appended claims. Thus, it is intended that the present invention cover the modifications and variations of this invention, provided they are within the scope of the appended claims and their equivalents.

I/We claim:

1. A tandem tip-driven rotor cum wing aircraft (100) having a vertical flight mode, and a horizontal flight mode, comprising:
an airframe (102) comprising a forward end (118) and an aft end (120);
a fuselage (104) longitudinally extended between the forward end (118) and the aft end (120) of the airframe (102);
a first rotor-wing (106) comprising a first rotatable portion and a second rotatable portion;
a second rotor-wing (108) comprising a third rotatable portion, and a fourth rotatable portion, wherein the first rotor-wing (106) and the second rotor-wing (108) are arranged in a tandem sequence and rotatably mounted on the fuselage (104), wherein each of the first rotor-wing (106) and the second rotor-wing (108) comprising a plurality of leading edges (110a, 110b, 110c, and 110d);
a plurality of servo motors (112a, 112b, 112c, and 112d), wherein each of the first rotatable portion, the second rotatable portion, the third rotatable portion, and the fourth rotatable portion are connected to their respective servo motors (112a, 112b, 112c, and 112d) which actuate the rotation motion of each rotatable portion individually on signals from a proportional-integral-derivative (PID) controller (802), wherein the PID controller (802) control each of the servo motors (112a, 112b, 112c, and 112d) of the first rotatable portion, the second rotatable portion, the third rotatable portion, and the fourth rotatable portion;
a plurality of thrusters (114a, 114b, 114c, and 114d) connected to each of the leading edges (110a, 110b, 110c, and 110d) of the first rotor-wing (106) and the second rotor-wing (108) to provide a plurality of thrust directions, wherein the PID controller (802) utilizes at least eight channels to control the servo motors (112a, 112b, 112c, and 112d), and the thrusters (114a, 114b, 114c, and 114d);
a first slip ring (116a) to connect the first rotor-wing (106) with the fuselage (104); and
a second slip ring (116b) to connect the second rotor-wing (108) with the fuselage (104), wherein the first slip ring (116a) and the second slip ring (116b) comprising a plurality of brakes to lock the first rotor-wing (106), and the second rotor-wing (108) perpendicular to the fuselage (104) in a transition from the vertical flight mode to the horizontal flight mode.

2. The tandem tip-driven rotor cum wing aircraft (100) as claimed in claim 1, wherein the airframe (102) comprises a flight controller (902) to manage and control a plurality of flight operations to ensure stable, safe, and autonomous flight.

3. The tandem tip-driven rotor cum wing aircraft (100) as claimed in claim 1, wherein, during vertical flight mode, the leading edges (110a, 110b, 110c, and 110d) and the thrust directions of both halves of each of the first rotor-wing (106) and the second rotor-wing (106) are oriented in different directions to enable the first rotor-wing (106) and the second rotor-wing (106) to spin and generate lift, thereby functioning as a tip-driven rotor aircraft.

4. The tandem tip-driven rotor cum wing aircraft (100) as claimed in claim 1, wherein each of the first rotor-wing (106) and the second rotor-wing (108) having a pitch (702) of both halves of each of the first rotor-wing (106) and the second rotor-wing (106) have a 180° range of motion to enhance stability and maneuverability during the vertical flight mode.

5. The tandem tip-driven rotor cum wing aircraft (100) as claimed in claim 1, wherein the fuselage (104) is elevated from the forward end (118) to avoid an intervention of the first rotor-wing (106), and the second rotor-wing (108).

6. The tandem tip-driven rotor cum wing aircraft (100) as claimed in claim 1, wherein the first rotor-wing (106), and the second rotor-wing (108), during the vertical flight mode, rotate in counter-rotation to produce a vertical lift.

7. The tandem tip-driven rotor cum wing aircraft (100) as claimed in claim 1, wherein the first rotor-wing (106), and the second rotor-wing (108), during the horizontal mode, are not rotating, and are positioned to produce forward movement as fixed wings.

8. The tandem tip-driven rotor cum wing aircraft (100) as claimed in claim 1, wherein the first rotor-wing (106) and the second rotor-wing (108) are connected to the fuselage (104) through the first slip ring (116a) and the second slip ring (116b) respectively for power and data-signal transmission to the servo motors (112a, 112b, 112c, and 112d) and a plurality of avionics (904) of the first rotor-wing (106), and the second rotor-wing (108) to ensure free rotation.

9. The tandem tip-driven rotor cum wing aircraft (100) as claimed in claim 1, wherein the first rotor-wing (106) and the second rotor-wing (108) comprise a plurality of pivot portions (122, and 124) with the servo motors (112a, 112b, 112c, and 112d) to actuate a varying pitch rotation electronically to provide a stable transition from the vertical flight mode to the horizontal flight mode.

10. The tandem tip-driven rotor cum wing aircraft (100) as claimed in claim 1, wherein the thrusters (114a, 114b, 114c, and 114d) move along with the varying pitch to create a thrust vectoring to provide efficient braking of the first rotor-wing (106), and the second rotor-wing (108).
